(19) United States
(12) Patent Application Publication
(10) Pub. No.: US 2022/0269958 A1
(43) Pub. Date: Aug. 25, 2022

(54) DEVICE-INVARIANT, FREQUENCY-DOMAIN SIGNAL PROCESSING WITH MACHINE LEARNING

(71) Applicant: SAMSUNG ELECTRONICS CO., LTD., Gyeonggi-do (KR)

(72) Inventors: Mohsin Yusuf Ahmed, Sunnyvale, CA (US); Li Zhu, Milpitas, CA (US); Korosh Vatanparvar, Santa Clara, CA (US); Md Mahbubur Rahman, San Jose, CA (US); Tousif Ahmed, San Jose, CA (US); Jilong Kuang, San Jose, CA (US); Jun Gao, Menlo Park, CA (US)

(21) Appl. No.: 17/245,951

(22) Filed: Apr. 30, 2021

Related U.S. Application Data
(60) Provisional application No. 63/177,670, filed on Apr. 21, 2021.
(60) Provisional application No. 63/151,358, filed on Feb. 19, 2021.

(51) Int. Cl. G06N 5/04; G06N 20/00

(52) U.S. Cl. CPC G06N 5/04; G06N 20/00

(57) ABSTRACT

Device-invariant, frequency-domain signal processing with machine learning includes retrieving with a host device a device-specific alien dataset corresponding to an alien device. The device-specific alien dataset is retrieved from a remote data storage device communicatively coupled with the host device. A plurality of frequency-domain features are extracted from the device-specific alien dataset and a machine learning model is trained using the plurality of frequency-domain features. The host device extracts frequency-domain features from signals generated by sensors operatively coupled with the host device. Real-time frequency bin adaptation of the frequency-domain features extracted by the host device is performed. Based on the frequency-domain features extracted by the host device, as adapted, an inference is performed using the machine learning model.

### CROSS-REFERENCE TO RELATED APPLICATIONS

This application claims the benefit of both U.S. Provisional Patent Application No. 63/151,358 filed on Feb. 19, 2021, which is fully incorporated herein by reference, and U.S. Provisional Patent Application No. 63/177,670 filed on Apr. 21, 2021, which is fully incorporated herein by reference.

### BACKGROUND

This disclosure relates to signal processing, and more particularly, to signals-based classification and regression using machine learning.

Sensor data can be obtained from various sensor-endowed devices that generate signals in response to different types of physical stimuli. Such devices include, for example, industrial and home automation systems, intelligent virtual assistants, smart speakers, smartphones, smartwatches, earbuds, and the like. The different types of sensors embedded in such devices include microphones, cameras, inertial measurement units (IMUs), radar, and the like. Signals generated by such sensors can be used, for example, to passively monitor a user's movement, gestures, or physical condition (e.g., heart rate and respiration). When coupled with machine learning capabilities, different devices can be trained to respond to a user's voice commands to control automated devices, to authenticate a user's voice, to monitor a user's health, or perform various other tasks. The tasks are implemented by performing classifications or regressions based on sensor-generated signals using one or more machine learning models.

### SUMMARY

In one or more embodiments, a method includes retrieving with a host device a device-specific alien dataset corresponding to an alien device, the retrieving from a remote data storage device communicatively coupled with the host device. The method includes training a machine learning model based on a plurality of frequency-domain features extracted from the device-specific alien dataset. The method includes extracting a plurality of frequency-domain features from signals generated by sensors operatively coupled with the host device. The method includes performing real-time frequency bin adaptation of the frequency-domain features extracted from signals generated by sensors operatively coupled with the host device. The method includes determining, based on the frequency-domain features extracted from signals generated by the sensors operatively coupled with the host device, as adapted, an inference using the machine learning model.

In one or more embodiments, a system includes a processor configured to initiate operations. The operations include retrieving with a host device a device-specific alien dataset corresponding to an alien device, the retrieving from a remote data storage device communicatively coupled with the host device. The operations include training a machine learning model based on a plurality of frequency-domain features extracted from the device-specific alien dataset. The operations include extracting a plurality of frequency-domain features from signals generated by sensors operatively coupled with the host device. The operations include performing real-time frequency bin adaptation of the frequency-domain features extracted from signals generated by sensors operatively coupled with the host device. The operations include determining, based on the frequency-domain features extracted from signals generated by the sensors operatively coupled with the host device, as adapted, an inference using the machine learning model.

In one or more embodiments, a computer program product includes one or more computer readable storage media having instructions stored thereon. The instructions are executable by a processor to initiate operations. The operations include retrieving with a host device a device-specific alien dataset corresponding to an alien device, the retrieving from a remote data storage device communicatively coupled with the host device. The operations include training a machine learning model based on a plurality of frequency-domain features extracted from the device-specific alien dataset. The operations include extracting a plurality of frequency-domain features from signals generated by sensors operatively coupled with the host device. The operations include performing real-time frequency bin adaptation of the frequency-domain features extracted from signals generated by sensors operatively coupled with the host device. The operations include determining, based on the frequency-domain features extracted from signals generated by the sensors operatively coupled with the host device, as adapted, an inference using the machine learning model.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 depicts an example computing environment that includes an example frequency-domain transformer and adapter.

FIG. 2 is a flowchart of an example method of transforming and adapting frequency-domain features for training a machine learning model.

FIG. 3 is a flowchart of an example method of adapting frequency-domain features extracted by a host device for use by the host device in performing an inference with a trained machine learning model.

FIG. 4 is a flowchart of an example method of augmenting a device-specific alien dataset for training a machine learning model.

FIG. 5 is a flowchart an example method of determining the number of frequency bins to use in performing frequency bin normalization and/or real-time frequency bin adaptation based on the battery level of a host device.

FIG. 6 depicts an example computing node.

FIG. 7 depicts an example portable device.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to signal processing, and more particularly, to signals-based classification and regression using machine learning. An ever-growing number of smartphones, wearables, hearables, and other smart devices like virtual assistants, as well as household appliances, are endowed with sensing capabilities. These devices can process sensing data derived from signals generated with various types of sensors such as microphones, accelerometers, gyroscopes, cameras, radar, and the like. Increasingly, the sensing data is processed using machine learning inferences. In a variety of applications, machine learning is used to make inferences (e.g., classifications or regressions) based on the sensing data from various sensors embedded in the devices.

Owing to device heterogeneity, however, a machine learning model developed with data obtained from one device (e.g., smartphone) does not perform as effectively when deployed on a different device (e.g., smartwatch, earbuds). Machine learning model developers, to train a model, often are forced to collect datasets with each different type of device on which a model is to be deployed. The result can be diminished reliability of the machine learning model and enhanced costs in terms of time, effort, and resources in collecting data for training the model for use on different types of devices. For the same reasons, existing machine learning models trained using datasets collected from older devices may not be usable in new devices. Training an existing machine learning model for use in a new device necessitates collecting with the new device a new dataset. Each new episode of data collection and annotation can cost multiple thousands of dollars depending on the nature of the data and the complexity of annotations with respect to the machine learning model. Moreover, there is no effective mechanism to evaluate the quality of data collected using machine learning applications running on different devices that incorporate the same model.

An aspect of the systems, methods, and computer program products disclosed herein is provisioning to a host device a device-specific alien dataset generated by an alien device and making the alien dataset usable by the host device. As defined herein, a “host device” is any device that performs an inference based on a host dataset using a machine learning model that has been trained using an alien dataset. Relatedly, the “alien device” is any device other than the host device As also defined herein, an “alien dataset” is device-specific data generated by an alien device and comprising either signals generated by sensor(s) operatively coupled with or integrated in the alien device and/or data derived from the signals using signal processing. An alien dataset can comprise any time series signal (e.g., acoustic, motional, RF) and can be collected or recorded and stored (e.g., on a cloud-based server) separately from a host dataset. A “host dataset,” as defined herein, is data comprising signals generated by one or more sensors operatively coupled with or integrated in the host device and captured by the host in real time and based on which the host determines inferences using a trained machine learning model.

The host device and alien device need not be identical in every respect. An aspect of systems, methods, and computer program products disclosed herein is mitigating the effects of device differences that affect the distributions of the respective datasets of the two devices. In some arrangements, frequency-domain features extracted from the alien dataset for training the machine learning model are transformed using a unique frequency bin transformation, and frequency-domain features extracted from the host dataset for determining inferences using the model are adapted using a unique frequency bin adaption. Transformation and adaptation mitigate differences in the distributions of the datasets, thereby enabling one type of device to use a dataset collected by another type of device. In other arrangements, a ratio of frequency responses by the host device and alien device to a wide-frequency sweep signal is employed to mitigate the differences. In still other arrangements, frequency-domain features that are correlated with the host device are mapped (e.g., using a deep learning neural network) and transformed to corresponding features of the alien device for determining the inference. Accordingly, even though extracted frequency-domain features can vary from one type device or software application version to another, the various arrangements enable a dataset from an alien device to be used by the host, eliminating the host device's burden of collecting a dataset before training and deploying a particular machine learning model.

Indeed, a single alien dataset can be used by many different types of device or with different software applications for training a specific machine learning model. For example, the same alien dataset generated by a smartphone can be used by a smartwatch, earbuds, and other such devices for training a machine learning model. A software application, for example, can implement a machine learning model for classifying a user's health condition based on biomarker signals by training the model on signals from a smartphone using a smartwatch to run the application.

Another aspect of the systems, methods, and computer program products disclosed herein is the generation of device-specific metadata descriptors, which are generated as part of data collection management. Through data collection management, multiple device-specific alien datasets for training a machine learning model can be collected by different alien devices and electronically stored (e.g., on a cloud-based data storage device) for later retrieval by a host device. Metadata descriptors generated for each of the different device-specific alien datasets can indicate the quantity and quality of the data, as well any factors relevant to identifying the suitability of the device-specific alien datasets with respect to a specific type of host device. Relevant factors can include, for example, the types of devices, their makes and models, as well as conditions under which a device generated a corresponding dataset.

A host device electronically searches the data store to select a specific alien dataset corresponding to an alien device that, based on one or more device-specific metadata descriptors, most closely matches the host device. The selected alien dataset is downloaded and used to train a particular machine learning model. If the host device's search yields a partial match, the procedures for mitigating differences in the distributions of the respective datasets are automatically invoked.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

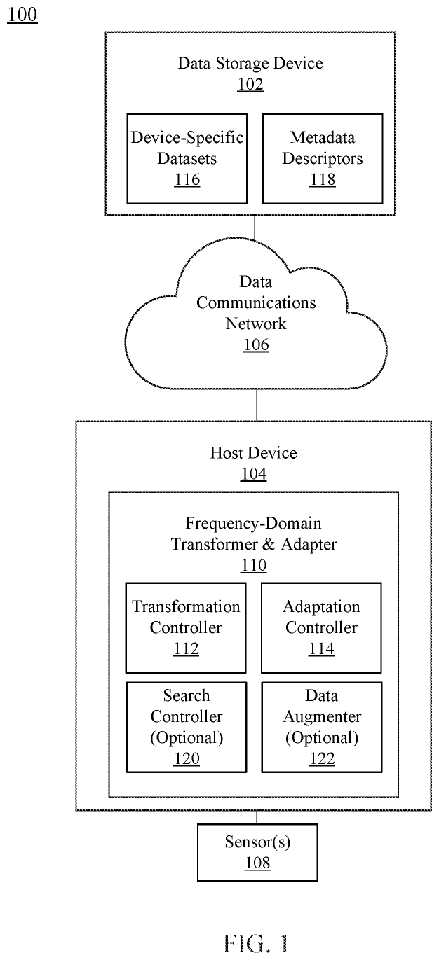

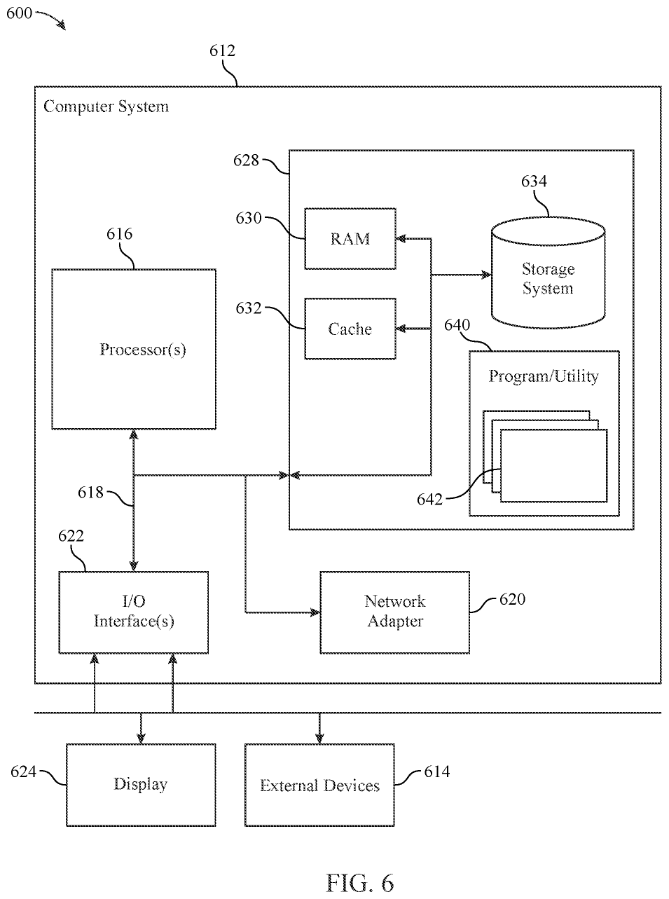

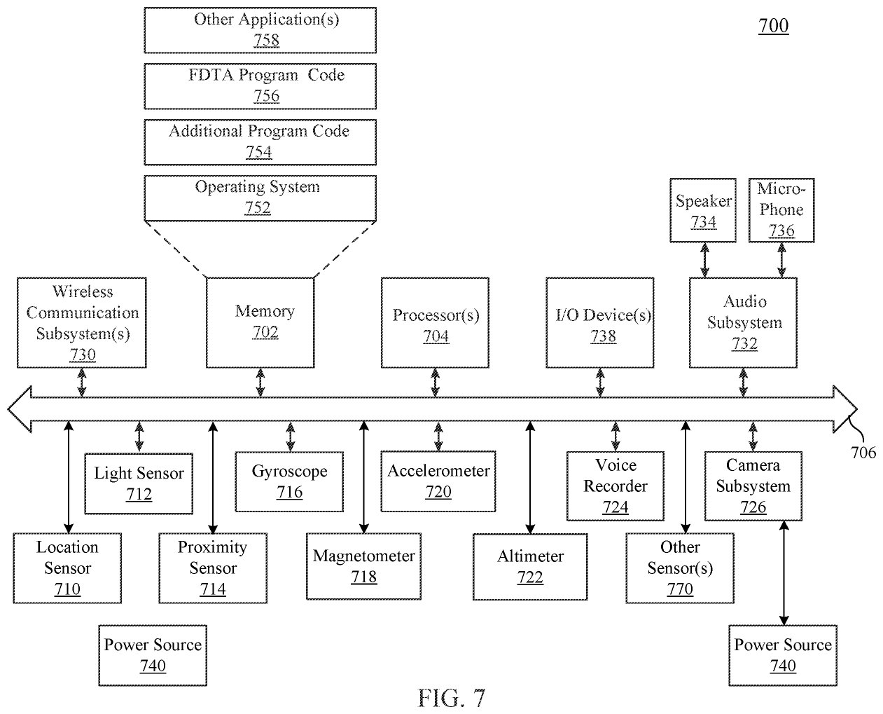

FIG. 1 depicts exam le computing environment 100. Computing environment 100 includes remote data storage device 102, host device 104, data communications network 106, and one or more sensors 108. Illustratively, data storage device 102 and host device 104 are communicatively coupled via data communications network 106, and sensor(s) 108 operatively couple to host device 104. Remote data storage device 102 can comprise a cloud-based or other network-connected computing node such as computing node 600, which illustratively includes computer system 612 (FIG. 6). Host device 104, in various arrangements, is a system such as computer system 612, having one or more processors 616 operatively coupled via bus 618 with memory 628 (FIG. 6). Host device 104 can be a device in which a computer system is embedded (e.g., smart home appliance). In various other arrangements, host device 104 is a portable device (e.g., laptop, smartphone, smartwatch, earbuds) having one or more of the components described with respect to portable device 700 (FIG. 7).

Data communications network 106 can include the Internet, one or more wide area networks (WANs), one or more local area networks (LANs), and/or various other data communications networks. Remote data storage device 102 and host device 104 can connect via data communications network 106 using wired and/or wireless connections.

Sensor(s) 108 can be incorporated in and/or operatively coupled, via wired or wireless connections, with host device 104. In various arrangements, sensor(s) 108 include microphones, accelerometers, gyroscopes, cameras, radar, biosensors, and/or other types of sensors for generating real-time signals in response to various stimuli. Signals generated by sensor(s) 108 can be modified, synthesized, and analyzed by host device 104 using continuous-time and/or discrete-time signal processing (e.g., fast Fourier transform) techniques. For example, in the context of sound processing, host device 104 can generate mel-frequency cepstrum coefficients (MFCC) corresponding to the power spectrum of sound. In other contexts, for example, host device 104 can generate Fourier transform coefficients, signal amplitudes or energy levels, and the like. In other contexts, for example, host device 104 can monitor and analyze a user's health based on sensor-generated signals corresponding to the user's heart rate and/or respiratory rate in real-time.

Moreover, the various types of signal processing tasks performed by host device 104 can be coupled with machine learning. Using a machine learning model trained in accordance with one or more supervised learning techniques, host device 104 can perform run-time inferences based on frequency-domain features extracted from sensor-generated signals. An inference can be a binary or multi-class classification based on the sensor-generated signals. For example, using a machine learning model, host device 104 can classify a user's heart condition as either normal or abnormal based on signals generated in real-time by host-coupled sensors in response to the user's heart rate. Using a different machine learning model, host device 104 can classify the user's respiratory condition based on signals generated by sensors embedded in host device 104, which monitors the user's breathing patterns based on real-time sensing of the user's chest movements. In these and other such arrangements, the inference made using the machine learning model is based on frequency-domain features extracted from signals generated in real time by sensor(s) 108 embedded in or operatively coupled with host device 104 or from electronically stored data representing the signals generated by sensor(s) 108.

The transfer of a machine learning model to host device 104 after the model is trained on a different, or alien, device can be problematic, however, owing to subtle differences in signal processing hardware, software applications used, and/or other factors related to the respective devices. Each device typically has a unique frequency response and though the differences in the frequency response across the different devices are subtle, the differences in frequency response can be computationally significant. A machine learning model trained for a certain machine learning task trained with data collected from an alien device may perform poorly if deployed on host device 104.

To improve the performance of a machine learning model trained on an alien device, host device 104 includes frequency-domain transformer and adapter (FDTA) 110. FDTA 110 illustratively comprises transformation controller 112 and adaptation controller 114. Transformation controller 112 and adaptation controller 114 can each be implemented in hardware, software, or a combination thereof In some embodiments in which transformation controller 112 and adaptation controller 114 are implemented in software, FDTA 110 can run as an operating system service on host device 104. Transformation controller 112 of FDTA 110 transforms frequency-domain features extracted from an alien dataset corresponding an alien device for training a machine learning model. Adaptation controller 114 of FDTA 110 adapts frequency-domain features extracted from a host dataset of a host device. The host device performs inferences based the frequency-domain features extracted from a host dataset using the machine learning model trained using the alien dataset.

Operatively, host device 104 retrieves a device-specific alien dataset for training a particular machine learning model. The device-specific alien dataset corresponds to a specific alien device (not shown) that generated the device-specific alien dataset based on signals generated in real time by one or more sensors operatively coupled with or embedded in the specific alien device. If the signals are continuous, the alien device can generate discrete samples, or instances, at discrete time intervals. For example, if Xₐ(t) is the signal value (e.g., amplitude) at time t, −∞<t<∞, then, the alien device generates a K-element dataset {X[k]}, k=1 . . . K, where X[k]=Xₐ(kT) and T is a predetermined sampling period. The device-specific alien dataset can be retrieved from among device-specific alien datasets 116, a plurality of alien datasets generated by different alien devices and electronically stored on remote data storage device 102.

Using, for example, fast Fourier transform (FFT), a device-specific alien dataset can be converted from the time domain to the frequency domain and each of a sequence of the samples, or instances, decomposed into components of different frequencies. Host device 104 based on the FFT can bin the frequencies, with each bin containing a partial segment of the full range of frequencies and the values (e.g., amplitudes) corresponding to the frequencies contained therein. Frequency-domain features extracted from the retrieved device-specific alien dataset and binned by host device 104 can be used by host device 104 to construct feature vectors comprising the distinct frequency-domain features for training the machine learning model.

Any differences between host device 104 and the alien device that generated the device-specific alien dataset or conditions under which the dataset was generated can contribute to differences in the frequency distributions between the dataset and a host dataset used for determining inferences using the machine learning model. To mitigate the differences transformation controller 112 performs frequency bin normalization on frequency-domain features extracted from the device-specific alien dataset, that is, specifically from each of the frequency bins in which the samples comprising the device-specific data are contained.

Transformation controller 112 performs frequency bin normalization on frequency-domain features extracted from the device-specific alien dataset during an alien feature transformation phase. With respect to each of N frequency bins, the frequency bin normalization executed by transformation controller 112 transforms N corresponding frequency-domain features (e.g., MFCCs) for each of M samples comprising the device-specific alien dataset captured by the specific alien device and downloaded to host device 104. The number of frequency bins, N, is predetermined. In some arrangements described in detail below the number of frequency bins, N, is determined based on the energy level of host device 104. With M samples for each of the N frequency bins, the extracted features can be represented as an M×N matrix:

$$F = [ \begin{matrix}{f}_{11} & … & {f}_{1 N} \\ ⋮ & ⋱ & ⋮ \\ {f}_{M 1} & … & {f}_{MN}\end{matrix} ] ,$$

where fⱼᵢ is the i-th extracted frequency-domain feature of the j-th sample.

In certain arrangements, transformation controller 112 performs frequency bin normalization on frequency-domain features extracted from the device-specific alien dataset by determining the mean, μᵢ(alien), and standard deviation, σᵢ(alien), of each frequency bin across all training samples acquired by the specific alien device:

$${μ}_{i} = \frac{Σ {f}_{ij}}{M} , j = 1 … M , i = 1 … N , and$$

$${σ}_{i} = \sqrt{\frac{\sum {( {f}_{ij} - {μ}_{i} )}^{2}}{M}} , j = 1 … M , i = 1 … N .$$

Each frequency bin feature of each sample of the alien device-captured dataset is transformed by transformation controller 112, which performs the following frequency bin normalization corresponding to each of the N frequency bins:

$${f}_{1}^{′} ( alien ) = \frac{{f}_{i} ( alien ) - {μ}_{2} ( alien )}{{σ}_{i} ( alien )} , i = 1 to N .$$

Host device 104 during a machine learning phase trains a particular machine learning model using the transformed features, f′ᵢ, corresponding to each of the N frequency bins. For any distance metric, D(p, q), that measures distance between two predetermined distributions, p and q, it is expected that D(dist′(host), dist′(alien))<D(dist(host), dist(alien)), where dist(device) and dist′(device) are, respectively, the distributions of a dataset generated by a device before and after frequency bin normalization.

Host device 104, during a subsequent inference phase, uses the machine learning model trained with the device-specific alien dataset collected by the alien device to perform an inference based on domain-frequency features extracted from signals generated by sensor(s) 108. As described above, the inference can be, for example, a classification of the user's heart condition based on frequency-domain features extracted from signals indicating the user's heart rate, identification of a respiratory condition based on frequency-domain features extracted from signals corresponding to the user's breathing patterns, for example, or other inference (e.g., classification, regression).

In the inference phase, adaptation controller 114 adapts the frequency-domain features extracted from each frequency bin of each sample generated from signals generated by sensor(s) 108 and captured by host device 104. The frequency-domain features extracted by host device 104 are adapted by a frequency bin adaptation executed in real time by adaptation controller 114 based on the alien device-captured dataset normalization parameters μᵢ(alien) and σᵢ(alien):

$${f}_{i}^{′} ( host ) = \frac{{f}_{i} ( host ) - {μ}_{i} ( alien )}{{σ}_{i} ( alien )} , i = 1 to N .$$

Note that because only the alien device-specific parameters μᵢ(alien) and σᵢ(alien) are needed for frequency-domain feature transformations and adaptations, frequency bin normalization can transform any device-specific alien dataset captured by an alien device to a host device for use at run time without any prior data being collected by the host device for training a machine learning model.

A numerical example illustrates the joint operative effect of the frequency bin normalization performed by transformation controller 112 and the real-time frequency bin adaptation performed by adaptation controller 114. Assume five instances or samples (in practice, the number is almost certainly much greater), each instance providing frequency-domain features from four distinct frequency bins, are collected by an alien device (e.g., smartphone). The resulting alien dataset corresponds to a 5×4 matrix:

$$[ \begin{matrix}- 211.95 & 200.12 & - 17.53 & 37.07 \\ - 228.2 & 191.55 & - 20.03 & 30.42 \\ - 260.79 & 157.58 & - 19.33 & 21.41 \\ - 280.69 & 174.2 & - 9.35 & 14.3 \\ - 303.6 & 171.08 & 7.22 & 7.98\end{matrix} ] .$$

Based on the alien dataset, transformation controller 112 determines for each of the four frequency bins a mean and standard deviation: μ₁=−257.05, μ₂=182.51, μ₃ =−11.81, μ₄=22.24, σ₁=37.44, σ₂=12.64, σ₃=11.46, and σ₄=11.77.

The frequency bin normalization performed by transformation controller 112 yields a set of normalized frequency-domain feature vectors for training, by host 104, a machine learning model. Each row of the following 5×4 matrix is a normalized frequency-domain feature vector:

$$[ \begin{matrix}1.2 & 1.39 & - 0.5 & 1.26 \\ 0.77 & 0.71 & - 0.72 & 0.69 \\ - 0.1 & - 0.54 & - 0.66 & - 0.07 \\ - 0.63 & - 0.65 & 0.21 & - 0.67 \\ - 1.24 & - 0.9 & 1.66 & - 1.21\end{matrix} ] .$$

Host device 104 (e.g., smartwatch) captures three instances or samples of domain-frequency features extracted from signals generated by sensor(s) 108. Each row of the following 3×4 matrix corresponds to the frequency-domain features of a sample:

$$[ \begin{matrix}- 414.45 & 89.31 & 41.19 & 45.37 \\ - 387.51 & 110.54 & 48.96 & 47.95 \\ - 349.27 & 140.8 & 52.28 & 42.98\end{matrix} ] .$$

Adaptation controller 114 adapts each frequency-domain feature corresponding to a frequency of the four frequency bins based on the respective alien dataset parameters, μᵢ(alien) and σᵢ(alien), generating f′ᵢ(host), for i=1 . . . N. The adaptation generates transformed vectors for input into the trained machine learning model. Each row of the following 3×4 matrix corresponds to a transformed vector:

$$[ \begin{matrix}- 4.2 & - 7.37 & 4.63 & 1.97 \\ - 3.48 & - 5.69 & 5.31 & 2.18 \\ - 2.46 & - 3.29 & 5.59 & 1.76\end{matrix} ] .$$

Host device 104 performs an inference (e.g., classification of user's health condition) based on the adapted input into the trained machine learning model.

In certain alternative arrangements, transformation controller 112 performs frequency bin normalization on frequency-domain features extracted from an alien dataset based on minimum and maximum values, minᵢ(alien) and maxᵢ(alien), respectively, of each frequency bin across all training samples obtained from the alien device. Transformation controller 112, based on the minimum and maximum values, minᵢ(alien) and maxᵢ(alien), performs the following alternative frequency bin normalization corresponding to each of the N frequency bins:

$${f}_{i}^{′} ( alien ) = \frac{{f}_{i (} alien ) - {min}_{i} ( alien )}{{max}_{i} ( alien ) - {min}_{i} ( alien )} , i = 1 to N .$$

Adaptation controller 114, during the inference phase, adapts frequency-domain features, fᵢ(host), extracted by host device 104 based on the minimum and maximum values, minᵢ(alien) and maxᵢ(alien). Adaptation controller 114 adapts the frequency-domain features by executing the following alternative frequency bin adaptation, which can be executed in real time:

$${f}_{i}^{′} ( host ) = \frac{{f}_{i (} host ) - {μ}_{i} ( alien )}{{max}_{i} ( alien ) - {min}_{i} ( alien )} , i = 1 to N .$$

In still other arrangements, FDTA 110 determines first, second, and third quartiles, Q1ᵢ(alien), Q2ᵢ(alien) and Q3ᵢ(alien), respectively, of each frequency bin across all training samples obtained from the alien device. Using the quartiles Q1ᵢ(alien), Q2ᵢ(alien) and Q3ᵢ(alien), transformation controller 112 performs still another alternative frequency bin normalization corresponding to each of the N frequency bins:

$${f}_{i}^{′} ( alien ) = \frac{{f}_{i (} alien ) - Q {2}_{i} ( alien )}{Q {3}_{i} ( alien ) - Q {1}_{i} ( alien )} , i = 1 to N .$$

Adaptation controller 114, using the quartiles Q1ᵢ(alien), Q2ᵢ(alien) and Q3ᵢ(alien), adapts the frequency-domain features extracted by host device 104 by executing yet another alternative frequency bin adaptation:

$${f}_{i}^{′} ( host ) = \frac{{f}_{i (} host ) - Q {2}_{i} ( alien )}{Q {3}_{i} ( alien ) - Q {1}_{i} ( alien )} , i = 1 to N .$$

In an alternative embodiment, FDTA 110 determines ratios, Rᵢ(host, alien)=f(host)ᵢ/f(alien)ᵢ, for i=1, . . . , N, corresponding to each of N frequency bins, each Rᵢ(host, alien) being the ratio of the i-th frequency response of the host to the i-th frequency response of the alien device. FDTA 110 extracts frequency-domain features from the alien dataset generated by the alien device without performing frequency bin normalization of the alien dataset. No feature transformation of the device-specific alien dataset is required. A machine learning model is trained using the device-specific alien dataset without normalizing extracted frequency-domain features. During run time, frequency-domain features extracted by host device 104 from real-time signals generated by sensor(s) 108 are adapted by adaptation controller 114 using Rᵢ(host, alien), for i=1, . . . , N. Host device 104 performs an inference based on the adapted frequency-domain features using the trained machine learning model.

Both the Rᵢ(host, alien) and alien device feature extractions can be determined in a remote device (e.g., cloud-based server) to effect host device energy saving. The Rᵢ(host, alien) and the trained machine learning model can then be retrieved to the host device from the remote device.

In another alternative embodiment, FDTA 110 transforms frequency-domain features extracted from the signals generated by sensors 108 operatively coupled with host device 104 by mapping the frequency-domain features to frequency-domain features extracted from the device-specific alien dataset captured by an alien device. The mapping can be performed, for example, by a deep learning neural network. The neural network is trained offline using training data from both host device 104 and the alien device. Through machine learning, the neural network is trained to transform extracted frequency-domain features by minimizing a cross entropy or root-mean-square-error between the frequency-domain features of samples of sensor-generated signals captured by the alien device and host device 104. The frequency transformation is consistent among all frames (e.g., audio frames) of the samples, such that the neural network learns the transformation based on input comprising individual frames of training data. Performing backpropagation during the training minimizes the mismatch between the distributions of the frequency-domain features extracted by the alien device and by host device 104. Backpropagation computes a gradient loss function with respect to weights of the neural network to accurately capture the transformation. Using the trained neural network, FDTA 110 transforms input frames (based on signals generated by sensors 108) to host device 104, which performs an inference based on classifying the input using the neural network.

FDTA 110, in certain embodiments, optionally includes search controller 120 (implemented in hardware, software, or a combination thereof) for performing one or more search procedures with respect to device-specific alien datasets 116 electronically stored on remote data storage device 102. Device-specific alien datasets 116 can comprise datasets that are each derived from electronic signals generated in real-time by one or more sensors of each alien device. Alternatively, or additionally, multiple device-specific alien datasets can be electronically stored on host device 104, itself, or an auxiliary device communicatively coupled via a wired or wireless connection with the host device 104.

Search controller 120 searches device-specific alien datasets 116 and selects one based on one or more metadata descriptors 118, which are uniquely associated with each of the datasets. Metadata descriptors 118 can be generated for each of device-specific alien datasets 116 by a data collection manager. Metadata descriptors 118 can indicate, for example, the quantity and quality of the data. Additionally, or alternatively, metadata descriptors 118 can include any factors relevant to identifying the suitability of the device-specific alien datasets. Suitability of a device-specific alien dataset with respect to host device 104 depends on the host device's specific type, as well as conditions under which host device 104 and the alien device generate machine learning datasets, the alien device generating the alien dataset for training the model and the host dataset generated by host device 104 for performing an inference using the model. Accordingly, metadata descriptors 118 can indicate, for example, the make and model of the alien device and the conditions under which data was collected by the alien device. Metadata descriptors 118 can indicate, for example, the quality and quantity of the data collected.

The data collection manager can determine the quality and quantity of the data collected by each alien device by continuously or intermittently monitoring the alien devices as the devices perform various operations for collecting sensor data and generating device-specific alien datasets based on sensor-generated signals. In some embodiments, the data collection manager monitors each alien device over a Bluetooth, Wi-Fi, or other wireless or wired connection. The data collection manager, through the monitoring, detects the start and end of an alien device's data collection, as well as intermediate events such as an acquisition interruption (e.g., system crash), restart after interruption, and the like. The data collection manager can timestamp and log each event. In some embodiments, the data collection manager operatively couples to one or more sensors for determining the conditions under which the data is acquired.

Search controller 120 can select a device-specific alien dataset corresponding to a specific alien device based on one or more metadata descriptors that indicate the degree of compatibility (e.g., in terms of hardware, software, and/or data collection conditions) between an alien device and host device 104. The greater the compatibility, the greater the reliability of the machine learning model trained by the host device using a dataset collected by the alien device.

An electronic search of device-specific alien datasets 116 is performed by search controller 120 to select a specific alien dataset corresponding to an alien device that, based on metadata descriptors 118, most closely matches host device 104. Host device 104 downloads the selected alien dataset and uses the dataset to train a particular machine learning model. Anything less than a one-to-one match between the specific metadata descriptors associated with an alien device and that of host device 104 is deemed a partial match by search controller 120. If the selected alien dataset corresponds to an alien device whose metadata descriptor(s) only partially match that of host device 104, FDTA 110 automatically invokes the procedures for frequency-domain normalization and adaptation. A “partial match,” as defined herein, is a comparison of metadata descriptors which indicates a possibility that the device-specific alien dataset generated by an alien device, without transformation of frequency-domain features extracted from the dataset, is not reliable for training the machine learning model to use on a specific host device. The frequency-domain feature normalization and the frequency-domain adaptation procedures are invoked in response to a partial match with the objective of reducing frequency domain shift due to differences in the host device and the selected alien device and/or conditions under which the device-specific alien dataset (for training the machine learning model) and the host dataset (for making inferences using the machine learning model) were collected. A one-to-one match between the alien device metadata descriptor(s) and host device 104 metadata descriptor(s) obviates the need to perform frequency bin transformation and adaptation before performing a run-time application of the machine learning model trained with the extracted frequency-domain features.

In searching, if search controller 120 does not find an alien device whose corresponding metadata descriptor(s) indicate a one-to-one match with host device 104, then search controller 120 seeks a partial match between an alien device and host device 104. Search controller 120 can perform the search based on a predetermined order of priority. In accordance with certain arrangements, transformation controller performs a priority-based search based on metadata descriptors that indicate each alien device's make, sub-model, model, type, and/or the amount of device-specific data associated with each alien device.

Search controller 120, in some embodiments, responds to a failure to find an alien device that identically matches host device 104 by initially searching for an alien device that is the same sub-model as host device 104. For example, if host device 104 is a Samsung Galaxy S10 smartphone, search controller 120 initially searches for an alien device (smartphone) that belongs to the Galaxy S series (e.g., S9). If none is identified, search controller 120 next searches for an alien device that is the same model as host device 104. For example, if the host device is a Samsung Galaxy S10 smartphone and there is no alien device (smartphone) that belongs to the Galaxy S series, then search controller 120 searches for any other Galaxy smartphone (e.g., Galaxy A51). If no device of the same model as host device 104 is identified, then search controller 120 searches for one that is the same type. For example, if host device 104 is a Samsung Galaxy S10 smartphone and no device belongs to the Galaxy S series, then search controller 120 searches for an alien device that is the same type as host device 104, that is, any other smartphone regardless of model. If none is identified, then search controller 120 selects from device-specific alien datasets 116 a device-specific alien dataset comprising the greatest amount of data.

Host device 104 at different times may operate under different ambient conditions, any of which can affect the host device's collection of data generated by sensor(s) 108 and, accordingly, the real-time frequency bin adaptation of the frequency-domain features extracted from host device data. Thus, in certain embodiments metadata descriptors 118 associated with each alien device and corresponding device-specific alien datasets indicate the condition under which the alien device collected the corresponding device-specific alien dataset.

Search controller 120, based on metadata descriptors 118. can consider the data collection conditions associated with each of device-specific alien datasets 116 when selecting a device-specific alien dataset for training the machine learning model. Priority can be given to the sub-model and model of the alien device, but in the event that there are multiple matches with host device 104, search controller 120 can select the device-specific alien dataset collected under conditions matching those under which the host device 104 is operating or is expected to operate in collecting data for making an inference using the machine learning model. For example, in collecting acoustic data based on audio signals, such conditions can include whether the data collection occurs indoors or outdoors, in a noiseless environment, in an environment subject to high winds, HVAC sounds, machine noises, or the like. In the context of measuring a user's heart rate or breathing patterns, the conditions can include the user's physical activity (e.g., at rest, engage in strenuous activity), level of stress, or other the like. FDTA 110 can operatively couples with sensor(s) 108 to determine the conditions under which host device 104 is operating.

In other embodiments, FDTA 110 additionally includes data augmenter 122 (implemented in hardware, software, or a combination thereof), which augments the device-specific alien dataset with an adapted inference dataset generated by host device 104 in response to determining that a distribution distance between the device-specific alien dataset and an adapted inference dataset is less than a predetermined threshold. The adapted inference dataset is a host dataset generated by host device 104, the adapted inference dataset providing the input based on which an inference is determined using the machine learning model. An augmenting procedure performed by data augmenter 122 includes initially verifying that an inference performed by host device 104 using the machine learning model trained with the device-specific alien dataset is a correct inference (e.g., user's health condition accurately classified). If the inference is verified as correct, a confidence (in a probabilistic sense) in the frequency-domain features used by host device 104 for performing the inference is determined. Data augmenter 122 makes the determination by measuring a distribution distance between the transformed device-specific alien dataset and the adapted and verified dataset used by host device 104 in performing the inference.

The distribution distance can be measured by data augmenter 122 using different statistical techniques for measuring distance between two multivariate distributions. For example, a Kolmogorov-Smirnov statistic quantifies a distance between an empirical distribution function of a sample and cumulative distribution function of the reference distribution, as well as the distance between empirical distribution functions of two samples. The Kullback-Leibler divergence, or relative entropy, measures the degree to which one probability distribution is different from another, reference probability distribution. Likewise, the Hellinger distance, and the Bhattacharyya distance are measures of similarity between two probability distributions.

If, based on such a measure, data augmenter 122 determines that the distance between two distributions is less than a predetermined amount, then data augmenter 122 augments the alien dataset transformed by transformation controller 112 by adding the dataset adapted by adaptation controller 114 to the transformed alien dataset. Augmentation enhances the predictive power of the machine learning model through refinement based on verified instances (e.g., classifications, regressions) specifically and uniquely generated by host device 104.

In still other embodiments in which host device 104 is powered by a battery, FDTA 110 detects the battery level and determines, based on the battery level, the number of frequency bins that are created for performing the frequency bin normalization and/or the real-time frequency bin adaptation. FDTA 110, depending on the specific circuitry of host device 104, can operatively couple with the battery management system, Coulomb counter, or other integrated circuit that determines the battery's state-of-charge (e.g., battery capacity gauge). FDTA 110 can divide the battery level into discrete ranges. The battery level can be periodically monitored by FDTA 110, and if a predetermined change in the battery level is detected, frequency-domain transformer revises an existing machine learning model, re-transforming frequency-domain features and re-training the model with an updated number, N, of frequency bin features. FDTA 110 increases N commensurate with increased battery levels, and conversely, decreases N with diminished battery levels.

Host device 104 extracts frequency-domain features based on the updated N frequency bins, performing frequency bin normalization, real-time frequency bin adaptation of the frequency-domain features extracted by the host device, and inference based on the revised machine learning model. Using this energy adaptive scheme, the battery life of host device 104 can be extended owing to reduced computation at lower battery levels.

In yet other embodiments, multiple versions of a trained machine learning model, each corresponding to a different number of frequency bins, are electronically stored either on a remote device such as remote data storage device 102 or memory of host device 104. At run-time, as a battery level change is detected by FDTA 110, a battery level-specific machine learning model is selected by FDTA 110 based on a correlation between the battery level and the number of frequency bins corresponding to the machine learning model. The procedure can further reduce power consumption and extend battery life by avoiding repeated transformations and training of a machine learning model by host device 104. Storing the multiple machine learning models on a remote device can eliminate the resource burden on host device 104 for storing the several machine learning models corresponding to varying numbers of frequency bins.

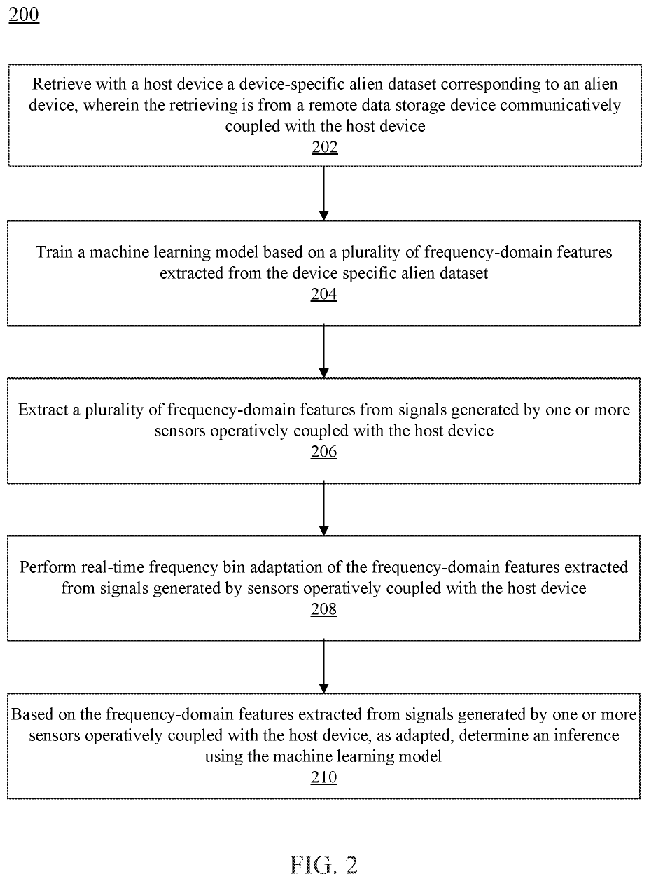

FIG. 2 is a flowchart of example method 200 of transforming and adapting frequency-domain features for training a machine learning model. The method, in various embodiments, can be performed with a system, such as FDTA 110, that is integrated in or operatively coupled to a host device (e.g., computer system, portable device) such as host device 104 (FIG. 1). Illustratively, the system at block 202 retrieves a device-specific alien dataset corresponding to an alien device. The retrieving is from a remote data storage, such as remote data storage device 102, communicatively coupled with the host device via a data communications network such as data communications network 106 (FIG. 1). At block 204, the system trains a machine learning model based on the plurality of frequency-domain features.

At block 206. a host device extracts a plurality of frequency-domain features from signals generated by one or more sensors operatively coupled with the host device. The frequency-domain features can be extracted, for example, from signals generated by one or more sensors such as sensor(s) 108 operatively coupled with host device 104. Frequency-domain features, in various embodiments, include mel-frequency cepstrum coefficients (MFCC), fast Fourier transform coefficients, frequency-domain amplitude, frequency=domain power, frequency-domain energy, and the like. Other frequency-domain features specifically related to audio signals, for example, include perceptive linear prediction (PLP) coefficients, perceptive linear prediction cepstral coefficients (PLPCC), line spectral frequencies, fundamental frequency, frequency components, spectral centroid, spectral features (e.g., flux, density, roll-off, arbitrary band energies, centroid, entropy, variance, skewness, kurtosis, slope), formant frequencies, and bandwidths. in various other contexts, frequency-domain features can be extracted from motional signals generated by various inertial measurement units (IMUs), RF signals generated by radar, and the like, as well as other types of signals generated by various other types of sensors.

In an example context, frequency-domain features are extracted in monitoring and analyzing a user's health based on sensor-generated signals corresponding to the user's heart rate (e.g., electrocardiogram signals). In another example, frequency-domain features are extracted from acoustic signals generated for example by a smartphone, smartwatch, or earbuds that sense coughing, wheezing, and/or other pulmonary or pulmonary-related sounds of the user in real-time for health monitoring and detecting, for example, obstructive lung disease such as asthma, chronic obstructive pulmonary disease (COPD), and infectious lung disease such as COVID-19.

At block 208, the system performs real-time frequency bin adaptation of the frequency-domain features extracted from signals generated by sensors operatively coupled with the host device. Real-time frequency bin adaptation of the frequency-domain features extracted by the system can be performed by an adaptation controller such as adaptation controller 114 (FIG, 1). The adaptation controller, using alien device-captured dataset normalization parameters μᵢ(alien) and σᵢ(alien), can adapt frequency-domain features, fᵢ(host), i=1 to N, corresponding to each of the N frequency bins of each sample from the host device based on the following frequency bin adaptation, which can be executed in real time:

$${f}_{i}^{′} ( host ) = \frac{{f}_{i} ( host ) - {μ}_{i} ( alien )}{{σ}_{i} ( alien )} , i = 1 to N .$$

In alternative embodiments, the adaptation controller using the alien device-captured dataset minimum and maximum values, minᵢ(alien) and maxᵢ(alien), respectively, can adapt frequency-domain features, fᵢ(host), i=1 to N, corresponding to each of the N frequency bins of each sample from the host device by executing an alternative frequency bin adaptation:

$${f}_{i}^{′} ( host ) = \frac{{f}_{i (} host ) - {min}_{i} ( alien )}{{max}_{i} ( alien ) - {min}_{i} ( alien )} , i = 1 to N .$$

In still other embodiments, the adaptation controller using the quartiles Q1ᵢ(alien), Q2ᵢ(alien) and Q3ᵢ(alien) of each frequency bin, can adapt frequency-domain features, fᵢ(host), i=1 to N, corresponding to each of the N frequency bins of each sample from the host device by executing yet another alternative frequency bin adaptation:

$${f}_{i}^{′} ( host ) = \frac{{f}_{i (} host ) - Q {2}_{i} ( alien )}{Q {3}_{i} ( alien ) - Q {1}_{i} ( alien )} , i = 1 to N .$$

Based on the frequency-domain features extracted from signals generated by one or more sensors operatively coupled with the host device, the system at block 210 determines an inference using the machine learning model

If there are differences between the host device and the alien device corresponding to the device-specific alien dataset, or between the conditions under which the datasets are generated by the devices, the differences can cause differences in the distributions of the respective datasets. Accordingly, the system automatically responds to mitigate the differences in the distributions of the datasets.

In some embodiments, the system performs frequency bin normalization on the plurality of frequency-domain features extracted from the device-specific alien dataset. Frequency bin normalization can be performed by a transformation controller such as transformation controller 112 (FIG. 1), The transformation controller can transform a frequency-domain feature, fᵢ(alien), corresponding to each of the N frequency bins of each sample from the alien device based on

$${f}_{i}^{′} ( alien ) = \frac{{f}_{i} ( alien ) - {μ}_{i} ( alien )}{{σ}_{i} ( alien )} , i = 1 to N ,$$

where μᵢ(alien) and σᵢ(alien) are normalization parameters for normalizing frequency-domain features extracted from the device-specific alien dataset generated by the alien device. In other embodiments, frequency-domain feature, fᵢ(alien), can be transformed based on the minimum and maximum values, minᵢ(alien) and maxᵢ(alien) of the corresponding frequency bin. The transformation controller, based on the minimum and maximum values, minᵢ(alien) and maxᵢ(alien), performs the following alternative frequency bin normalization corresponding to each of the N frequency bins:

$${f}_{i}^{′} ( alien ) = \frac{{f}_{i (} alien ) - {min}_{i} ( alien )}{{max}_{i} ( alien ) - {min}_{i} ( alien )} , i = 1 to N .$$

And in still other embodiments, frequency-domain feature, fᵢ(alien), can be transformed based on first, second, and third quartiles, Q1ᵢ(alien), Q2ᵢ(alien) and Q3ᵢ(alien), respectively, of the corresponding frequency bin. Based on first, second, and third quartiles, Q1ᵢ(alien), Q2ᵢ(alien) and Q3ᵢ(alien), the transformation controller performs still another alternative frequency bin normalization corresponding to each of the N frequency bins:

$${f}_{i}^{′} ( alien ) = \frac{{f}_{i (} alien ) - Q {2}_{i} ( alien )}{Q {3}_{i} ( alien ) - Q {1}_{i} ( alien )} , i = 1 to N .$$

The frequency bin normalization is performed on the plurality of frequency-domain features after the frequency-domain features are extracted from the device-specific alien dataset at step 202 and prior to training the machine learning model. Once the frequency-domain features are transformed, the frequency-domain features, as transformed, are then used to train the machine learning model at step 204.

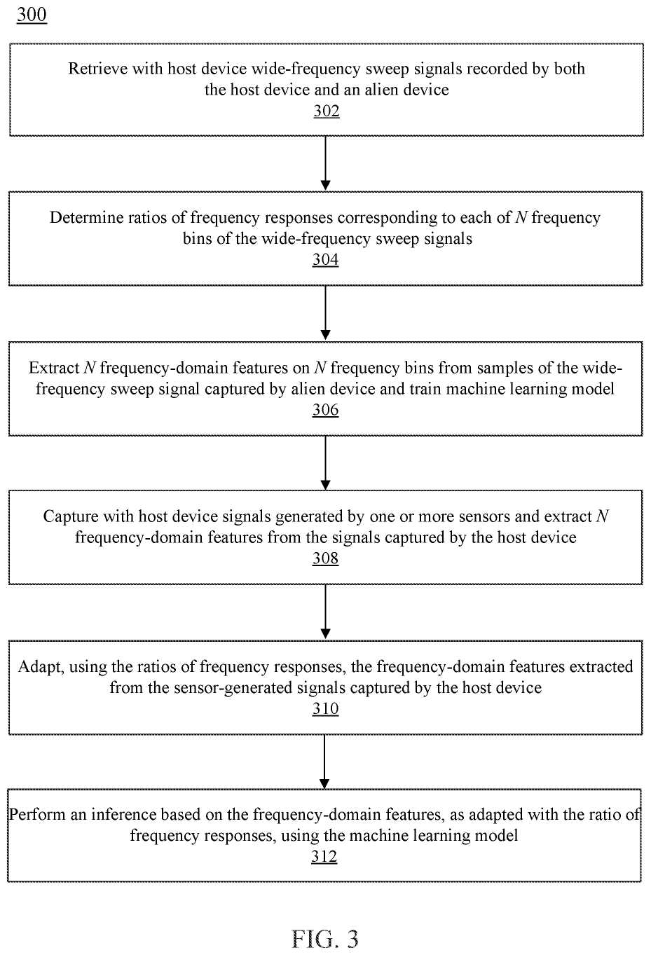

Referring additionally now to FIG. 3, in other embodiments pertaining to mitigating distribution differences, the determining the inference is based on a ratio of frequency responses to a wide-frequency sweep signal by the host device and the alien device. FIG. 3 is a flowchart of example method 300 of performing the real-time frequency bin adaptation based on a ratio of frequency responses to wide-frequency sweep signals collected by the host device and the alien device. The adapting can be performed by the system using an adaption controller, such as adaptation controller 114, that is integrated in or operatively coupled to the host device (FIG. 1).

At block 302, the system retrieves wide-frequency sweep signals recorded by both the host device and an alien device. The wide-frequency sweep signals can be recorded separately and/or at different times by the host device and alien device, but both span the same range of frequencies. The system at block 304 determines ratios, Rᵢ(host, alien), for i=1, . . . , N of the frequency responses of the host device and the alien device corresponding to each of N frequency bins of the wide-frequency sweep signals, where Rᵢ(host, alien)=f(host)ᵢ/f(alien)ᵢ, defined as above.

At block 306, the system extracts N frequency-domain features on N frequency bins from samples of the wide-frequency sweep signal captured by the alien device and trains the machine learning model. The host device at block 308 captures signals generated by one or more sensors integrated in or communicatively coupled with the host device, which extracts N frequency-domain features from the signals.

At block 310, the system, using the ratios of frequency responses, adapts the frequency-domain features extracted from the sensor-generated signals captured by the host device. The frequency-domain features are adapted by dividing each extracted feature within each frequency bin by a corresponding feature from the alien dataset for the same frequencies, R′ᵢ(host, alien)=f′(host)ᵢ/f(alien)ᵢ, where f′(host) is the frequency-domain feature extracted from the sensor-generated signals corresponding to the i-th frequency bin. The host device at block 312 performs an inference based on the frequency-domain features, as adapted with the ratio of frequency responses, using the machine learning model.

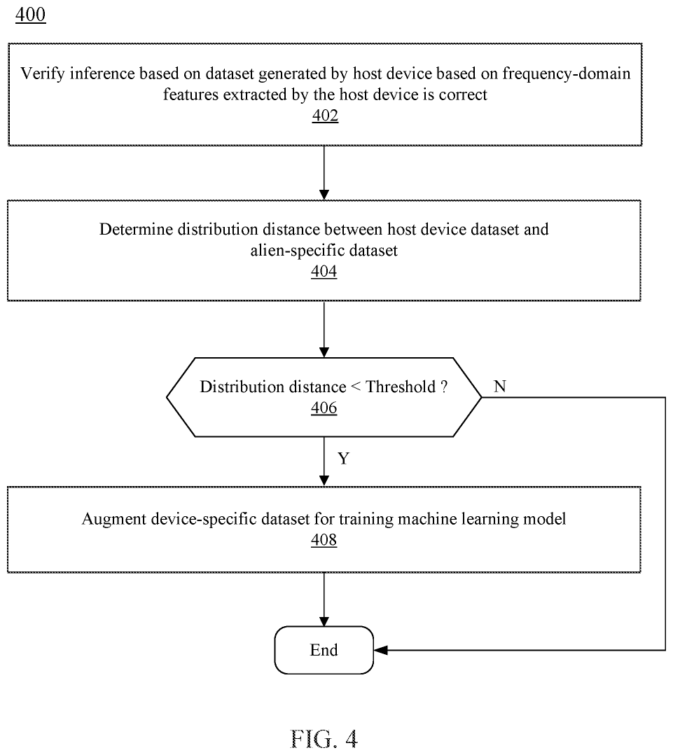

Referring additionally now to FIG. 4, in still other embodiments, the system augments a device-specific alien dataset with a dataset generated by the host device in performing inferences that are verified as correct. Data augmentation can be performed by the system using a data augmenter such as data augmenter 122 (FIG. 1). Augmentation can provide labeled training examples that can be added to the device-specific alien dataset and used to refine the machine learning model through additional supervised learning with the augmented dataset. FIG. 4 is a flowchart of an example method of augmenting a device-specific alien dataset for training a machine learning model.

At block 402, the system verifies whether an inference made using the machine learning model trained with the device-specific alien dataset is correct. If correct, a confidence level in the frequency-domain features extracted by the host device on which the inference is made is determined by the system at block 404. The system makes the determination by measuring the distance between the device-specific alien dataset as normalized (the transformed training dataset used to train the machine :learning model) and the adapted host device dataset on which the inference is based. The distance can be measured using any of various techniques for measuring distance between two multi-variate distributions, such as the Kolmogorov-Smirnov distance, the Kullback-Leibler divergence, the Hellinger distance, or the Bhattacharyya distance, for example. If at block 406, the system determines that the distribution distance is less than a predetermined threshold, the system augments the device-specific alien dataset at block 408.

In another embodiment, the system performs frequency bin normalization by transforming the frequency-domain features extracted from the signals generated by sensors operatively coupled with the host device, wherein the transforming maps the frequency-domain features extracted from the signals generated by sensors operatively coupled with the host device to the plurality of frequency-domain features extracted from the device-specific alien dataset. The system can perform the frequency bin normalization using a transformation controller such as transformation controller 112 (FIG. 1). The system maps the frequency-domain features extracted from the signals generated by sensors operatively coupled with the host device to the plurality of frequency-domain features extracted from the device-specific alien dataset. The mapping can be performed using the deep learning neural network, as described above.

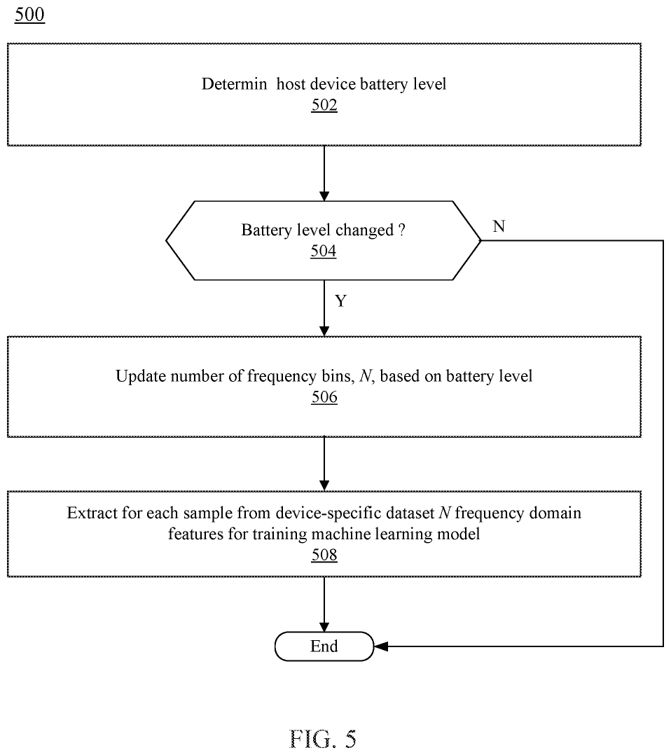

Referring additionally now to FIG. 5, in other embodiments, the system detects a battery level of the host device and determines, based on the battery level, the number of frequency bins used in performing frequency bin normalization and/or the real-time frequency bin adaptation by the host device. FIG. 5 is a flowchart of example method 500 determining the number of frequency bins to use for performing frequency bin normalization and/or the real-time frequency bin adaptation based on the battery level of the host device.

At block 502, the system determines the battery level of the host device prior to or after retrieving the device-specific alien dataset corresponding to the alien device. If at block 504, the system determines that the battery level has changed, the system at block 506 updates the number of frequency bins, N, based on the battery level of the host device determined at block 502. The system increases N for increased battery levels and decreases N for decreased battery levels. At block 506, the system extracts N frequency domain features for each sample from the device-specific alien dataset. The machine learning model is then trained using the frequency domain features extracted based on the updated number of frequency bins, N.

The device-specific alien dataset retrieved by the system can be one selected by the system from a plurality of device-specific alien datasets. Each of the plurality of device-specific alien datasets derived from electronic signals generated in real-time by one or more sensors of one of a plurality of alien devices.

The system can select a device-specific alien dataset based on metadata descriptors corresponding to each of the plurality of device-specific alien datasets. The metadata descriptors can be generated by a data collection manager that monitors data collection by the plurality of alien devices. The data collection manager, in some embodiments, can operate on a remote device—either the same device that provides data storage (e.g., remote data storage device 102) or a separate remote device communicatively coupled via a wired or wireless connection with a remote device. The plurality of device-specific alien datasets, for example, can be provided on a cloud-based server by a service provider. A device-specific alien dataset selected based on the metadata descriptors can be downloaded to the host device by the system for training a machine learning model.

In other embodiments, the data collection manager can be integrated in or operatively coupled with the host device with which the system is operable. A host device user is thus able to compile different device-specific alien datasets generated by different user devices. The different device-specific alien datasets can be either electronically stored on the host device, locally, or for the sake of conserving host device resources, uploaded to a remote device, such as a cloud-based server.

Operatively, the data collection manager monitors the data collection by various alien devices to determine generally the quality and quantity of data collected by each alien device. In some embodiments, the data collection manager monitors each alien device over a Bluetooth, Wi-Fi, or other wireless or wired connection. The data collection manager through monitoring detects the start and end of an alien device's data collection, as well as intermediate events such as an acquisition interruption (e.g., system crash), restart after interruption, and the like. The data collection manager can timestamp and log each event. In some embodiments, the data collection manager operatively couples to one or more sensors for determining the conditions under which the data is acquired. For example, in the context of acquiring acoustic data, the data collection manager can include or operatively couple with a microphone to determine the ambient condition under which a device acquires the acoustic data. Alternatively, the data collection manager can record user input that designates the ambient condition.

In searching for a device-specific alien dataset based, the system may determine based on the metadata descriptors that an appropriate device-specific alien dataset is incomplete owing to some event (e.g., system crash). In the event that only a partially complete dataset is available, the system downloads the partial dataset and initiates a search for a dataset captured by another alien device that most closely matches the host device. If another alien device is identified, a device-specific alien dataset corresponding to the alien device is downloaded to provide additional data that supplements the partial dataset. The system can perform the search based on metadata descriptors, such as metadata descriptors 118, using a search controller, such as search controller 120 (FIG. 1). The system can merge one or more partial datasets from different alien devices and perform the frequency bin normalization and adaptation operations to reduce within-dataset frequency mismatch among the partial datasets that are merged into a complete dataset. The system can use a transformed and adapted dataset constructed from the merger of partial datasets from multiple alien devices to extract frequency-domain features for training the machine learning model.

FIG. 6 depicts example computing node 600. In one or more embodiments, computing node 600 is an example of a suitable cloud computing node. Computing node 600 is not intended to suggest any limitation as to the scope of use or functionality of embodiments of the invention described herein. Computing node 600 is capable of performing any of the functionality described within this disclosure.

Computing node 600 includes computer system 612, which is operational with numerous other general-purpose or special-purpose computing system environments or configurations. Examples of well-known computing systems, environments, and/or configurations that may be suitable for use with computer system 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 612 may be described in the general context of computer system-executable instructions, such as program modules, being executed by a computer system. Generally, program modules may include routines, programs, objects, components, logic, data structures, and so on that perform particular tasks or implement particular abstract data types. Computer system 612 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system 612 is shown in the form of a general-purpose computing device. The components of computer system 612 may include, but are not limited to, one or more processors 616, a memory 628, and a bus 618 that couples various system components including memory 628 to processor(s) 616. As defined herein, “processor” means at least one hardware circuit configured to carry out instructions. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

The carrying out of instructions of a computer program by a processor comprises executing or running the program. As defined herein, “run” and “execute” comprise a series of actions or events performed by the processor in accordance with one or more machine-readable instructions. “Running” and “executing,” as defined herein refer to the active performing of actions or events by the processor. The terms run, running, execute, and executing are used synonymously herein. Relatedly, as defined herein, “run time” refers to a time during which a processor is executing or running a computer program.

Bus 618 represents one or more of any of several types of bus structures, including a memory bus or memory controller, a peripheral bus, an accelerated graphics port, and a processor or local bus using any of a variety of bus architectures. By way of example only, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and PCI Express (PCIe) bus.

Computer system 612 typically includes a variety of computer system-readable media. Such media may be any available media that is accessible by computer system 612, and may include both volatile and non-volatile media, removable and non-removable media.

Memory 628 may include computer system readable media in the form of volatile memory, such as random-access memory (RAM) 630 and/or cache memory 632. Computer system 612 may further include other removable/non-removable, volatile/non-volatile computer system storage media. By way of example, storage system 634 can be provided for reading from and writing to a non-removable, non-volatile magnetic media and/or solid-state drive(s) (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein. For example, one or more of the program modules may comprise an FDTA, such as FDTA 110 (FIG. 1), or portions thereof.

Program/utility 640 is executable by processor 616. Program/utility 640 and any data items used, generated, and/or operated upon by computer system 612 are functional data structures that impart functionality when employed by computer system 612. As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor.

Computer system 612 may also communicate with one or more external devices 614 such as a keyboard, a pointing device, a display 624, etc.; one or more devices that enable a user to interact with computer system 612; and/or any devices (e.g., network card, modem, etc.) that enable computer system 612 to communicate with one or more other computing devices. Such communication can occur via input/output (I/O) interfaces 622. Still, computer system 612 can communicate with one or more networks such as a local area network (LAN), a general wide area network (WAN), and/or a public network (e.g., the Internet) via network adapter 620. As depicted, network adapter 620 communicates with the other components of computer system 612 via bus 618. It should be understood that although not shown, other hardware and/or software components could be used in conjunction with computer system 612. Examples, include, but are not limited to: microcode, device drivers, redundant processing units, external disk drive arrays, RAID systems, tape drives, and data archival storage systems, etc.

While computing node 600 is used to illustrate an example of a cloud computing node, it should be appreciated that a computer system using an architecture the same as or similar to that described in connection with FIG. 6 may be used in a non-cloud computing implementation to perform the various operations described herein. In this regard, the example embodiments described herein are not intended to be limited to a cloud computing environment. Computing node 600 is an example of a data processing system. As defined herein, “data processing system” means one or more hardware systems configured to process data, each hardware system including at least one processor programmed to initiate operations and memory.

Computing node 600 is an example of computer hardware. Computing node 600 may include fewer components than shown or additional components not illustrated in FIG. 6 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

Computing node 600 is also an example of a server. As defined herein, “server” means a data processing system configured to share services with one or more other data processing systems. As defined herein, “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. In one or more embodiments, the various user devices described herein may be client devices. Network infrastructure, such as routers, firewalls, switches, access points and the like, are not client devices as the term “client device” is defined herein.

FIG. 7 illustrates example portable device 700 in accordance with one or more embodiments described within this disclosure. Portable device 700 can include a memory 702, one or more processors 704 (e.g., image processors, digital signal processors, data processors), and interface circuitry 706.

In one aspect, memory 702, processor(s) 704, and/or interface circuitry 706 are implemented as separate components. In another aspect, memory 702, processor(s) 704, and/or interface circuitry 706 are integrated in one or more integrated circuits. The various components of portable device 700 can be coupled, for example, by one or more communication buses or signal lines (e.g., interconnects and/or wires). In one aspect, memory 702 may be coupled to interface circuitry 706 via a memory interface (not shown).

Sensors, devices, subsystems, and/or input/output (I/O) devices can be coupled to interface circuitry 706 to facilitate the functions and/or operations described herein, including the generation of sensor data. The various sensors, devices, subsystems, and/or I/O devices may be coupled to interface circuitry 706 directly or through one or more intervening I/O controllers (not shown).

For example, location sensor 710, light sensor 712, and proximity sensor 714 can be coupled to interface circuitry 706 to facilitate orientation, lighting, and proximity functions, respectively, of portable device 700. Location sensor 710 (e.g., a GPS receiver and/or processor) can be connected to interface circuitry 706 to provide geo-positioning sensor data. Electronic magnetometer 718 (e.g., an integrated circuit chip) can be connected to interface circuitry 706 to provide sensor data that can be used to determine the direction of magnetic North for purposes of directional navigation. Accelerometer 720 can be connected to interface circuitry 706 to provide sensor data that can be used to determine change of speed and direction of movement of a device in three dimensions. Altimeter 722 (e.g., an integrated circuit) can be connected to interface circuitry 706 to provide sensor data that can be used to determine altitude. Voice recorder 724 can be connected to interface circuitry 706 to store recorded utterances.

Camera subsystem 726 can be coupled to an optical sensor 728. Optical sensor 728 can be implemented using any of a variety of technologies. Examples of optical sensor 728 include a charged coupled device (CCD), a complementary metal-oxide semiconductor (CMOS) optical sensor, and the like. Camera subsystem 726 and optical sensor 728 can be used to facilitate camera functions, such as recording images and/or video clips (hereafter “image data”). In one aspect, image data is a subset of sensor data.

Communication functions can be facilitated through one or more wireless communication subsystems 730. Wireless communications subsystem(s) 730 can include radio frequency receivers and transmitters, optical (e.g., infrared) receivers and transmitters, and so forth. The specific design and implementation of wireless communication subsystem(s) 730 can depend on the specific type of portable device 700 implemented and/or the communication network(s) over which portable device 700 is intended to operate.

For purposes of illustration, wireless communication subsystem(s) 730 may be designed to operate over one or more mobile networks (e.g., GSM, GPRS, EDGE), a Wi-Fi network that may include a WiMax network, a short-range wireless network (e.g., a Bluetooth network), and/or any combination of the foregoing. Wireless communication subsystem(s) 730 can implement hosting protocols such that portable device 700 can be configured as a base station for other wireless devices.

Audio subsystem 732 can be coupled to speaker 734 and microphone 736 to facilitate voice-enabled functions, such as voice recognition, voice replication, digital recording, audio processing, and telephony functions. Audio subsystem 732 is able to generate audio type sensor data. In one or more arrangements, microphone 736 may be utilized as a respirator or other biomarker sensor.

I/O devices 738 can be coupled to interface circuitry 706. Examples of I/O devices 738 include, for example, display devices, touch-sensitive display devices, track pads, keyboards, pointing devices, communication ports (e.g., USB ports), network adapters, buttons or other physical controls, and so forth. A touch-sensitive device such as a display screen and/or a pad is configured to detect contact, movement, breaks in contact, and the like using any of a variety of touch sensitivity technologies. Example touch-sensitive technologies include, for example, capacitive, resistive, infrared, and surface acoustic wave technologies, other proximity sensor arrays or other elements for determining one or more points of contact with a touch-sensitive device, and the like. One or more of I/O devices 738 may be adapted to control functions of sensors, subsystems, and such of portable device 700.

Portable device 700 further includes a power source 740. Power source 740 is able to provide electrical power to various elements of portable device 700. In one embodiment, power source 740 is implemented as one or more batteries. The batteries may be implemented using any of a variety of different battery technologies, whether disposable (e.g., replaceable) or rechargeable. In another embodiment, power source 740 is configured to obtain electrical power from an external source and provide power (e.g., DC power) to the elements of portable device 700. In the case of a rechargeable battery, power source 740 further may include circuitry that is able to charge the battery or batteries when coupled to an external power source.

Memory 702 can include random access memory (e.g., volatile memory) and/or non-volatile memory, such as one or more magnetic disk storage devices, one or more optical storage devices, flash memory, and so forth. Memory 702 can store operating system 752, such as LINUX, UNIX, a mobile operating system, an embedded operating system, and the like. Operating system 752 may include instructions for handling system services and for performing hardware-dependent tasks.

Memory 702 may store additional program code 754. Examples of additional program code 754 may include instructions to facilitate communicating with one or more additional devices, one or more computers, and/or one or more servers; graphic user interface processing; processing instructions to facilitate sensor-related functions; phone-related functions; electronic messaging-related functions; Web browsing-related functions; media processing-related functions; GPS and navigation-related functions; security functions; camera-related functions, including Web camera and/or Web video functions; and so forth. Memory 702 may store FDTA program code 756, which provides executable instructions for performing the functions of an FDTA, such as FDTA 110, for training a machine learning model and performing inferences using the model, as described herein. Memory 702 may also store one or more other applications 758, including one or more applications that include a machine learning model for performing inferences (e.g., classification, regression).

The various types of instructions and/or program code described are provided for purposes of illustration and not limitation. The program code may be implemented as separate software programs, procedures, or modules. Memory 702 can include additional instructions or fewer instructions. Moreover, various functions of portable device 700 may be implemented in hardware and/or software, including in one or more signal processing and/or application-specific integrated circuits.

Program code stored within memory 702 and any data used, generated, and/or operated on by portable device 700 are functional data structures that impart functionality to a device when employed as part of the device. Further examples of functional data structures include, for example, sensor data, data obtained via user input, data obtained via querying external data sources, baseline information, and so forth. The term “data structure” refers to a physical implementation of a data model's organization of data within a physical memory. As such, a data structure is formed of specific electrical or magnetic structural elements within a memory. A data structure imposes physical organization on the data stored in the memory that is used by a processor.

In certain embodiments, one or more of the various sensors and/or subsystems described with reference to portable device 700 may be separate devices that are coupled or communicatively linked to portable device 700 through wired or wireless connections. For example, one or more (or all) of location sensor 710, light sensor 712, proximity sensor 714, gyroscope 716, magnetometer 718, accelerometer 720, altimeter 722, voice recorder 724, camera subsystem 726, audio subsystem 732, and so forth may be implemented as separate systems or subsystems that operatively couple to portable device 700 by way of I/O devices 738 and/or wireless communication subsystem(s) 730.

Portable device 700 can include fewer components than those shown or include additional components other than those shown in FIG. 7 depending on the specific type of system that is implemented. Additionally, the particular operating system and/or application(s) and/or other program code included may also vary according to system type. Moreover, one or more of the illustrative components can be incorporated into, or otherwise form a portion of, another component. For example, a processor may include at least some memory.

Portable device 700 is provided for purposes of illustration and not limitation. A device and/or system configured to perform the operations described herein may have a different architecture than illustrated in FIG. 7. The architecture may be a simplified version of portable device 700 and may include a processor and memory storing instructions. The architecture may include one or more sensors as described herein. Portable device 700, or a similar system, can collect data using the various sensors of the device or sensors coupled thereto. It should be appreciated, however, that portable device 700 may include fewer sensors or other additional sensors. With this disclosure, data generated by a sensor is referred to as “sensor data.”

Example implementations of portable device 700 include, for example, a smartphone or other mobile device or phone, a wearable computing device (e.g., smartwatch, earbuds), a dedicated medical device or other suitable handheld, wearable, or comfortably carriable electronic device, capable of sensing and processing sensor-generated signals and data. It will be appreciated that embodiments can be deployed as a standalone device or deployed as multiple devices in a distributed client-server networked system. For example, in certain embodiments, a smartwatch can operatively couple to a mobile device (e.g., smartphone). The mobile device may or may not be configured to interact with a remote server and/or computer system.

The terminology used herein is for the purpose of describing particular embodiments only and is not intended to be limiting. Notwithstanding, several definitions that apply throughout this document now will be presented.

As defined herein, the singular forms “a,” “an,” and “the” include the plural forms as well, unless the context clearly indicates otherwise.

As defined herein, “another” means at least a second or more.

As defined herein, “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, “automatically” means without user intervention.

As defined herein, “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, “if” means “in response to” or “responsive to,” depending upon the context. Thus, the phrase “if it is determined” may be construed to mean “in response to determining” or “responsive to determining” depending on the context. Likewise the phrase “if [a stated condition or event] is detected” may be construed to mean “upon detecting [the stated condition or event]” or “in response to detecting [the stated condition or event]” or “responsive to detecting [the stated condition or event]” depending on the context.

As defined herein, “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the phrases “in response to” and “responsive to” mean responding or reacting readily to an action or event. Thus, if a second action is performed “in response to” or “responsive to” a first action, there is a causal relationship between an occurrence of the first action and an occurrence of the second action. The phrases “in response to” and “responsive to” indicate the causal relationship.

As defined herein, “real time” means a level of processing responsiveness that a user or system senses as sufficiently immediate for a particular process or determination to be made, or that enables the processor to keep up with some external process.

As defined herein, “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, “user” refers to a human being.

The terms first, second, etc. may be used herein to describe various elements. These elements should not be limited by these terms, as these terms are only used to distinguish one element from another unless stated otherwise or the context clearly indicates otherwise.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
retrieving with a host device a device-specific alien dataset corresponding to an alien device, wherein the retrieving is from a remote data storage device communicatively coupled with the host device;
training a machine learning model based on a plurality of frequency-domain features extracted from the device-specific alien dataset;
extracting a plurality of frequency -domain features from signals generated by sensors operatively coupled with the host device;
performing a real-time frequency bin adaptation of the frequency-domain features extracted from signals generated by sensors operatively coupled with the host device; and
based on the frequency-domain features extracted from signals generated by the sensors operatively coupled with the host device, as adapted, determining an inference using the machine learning model.

2. The method of claim 1, further comprising selecting the device-specific alien dataset from a plurality of device-specific alien datasets, wherein each of the plurality of device-specific alien datasets is derived from electronic signals captured by one or more sensors of one of a plurality of alien devices, wherein the selecting is based on metadata descriptors generated by a data collection manager.

3. The method of claim 1, further comprising performing a frequency bin normalization on the plurality of frequency-domain features extracted from the device-specific alien dataset, wherein the training comprises training the machine learning model based on the plurality of frequency-domain features as normalized.

4. The method of claim 1, wherein the determining is based on a ratio of frequency responses to a wide-frequency sweep signal by the host device and the alien device.

5. The method of claim 1, further comprising detecting a battery level of the host device and determining, based on the battery level, a number of frequency bins for performing at least one of a frequency bin normalization or a real-time frequency bin adaptation by the host device.

6. The method of claim 1, further comprising augmenting the device-specific alien dataset with an adapted inference dataset generated by the host device in response to determining that a distribution distance between the device-specific alien dataset and the adapted inference dataset is less than a predetermined threshold.

7. The method of claim 1, further comprising transforming the frequency-domain features extracted from the signals generated by sensors operatively coupled with the host device, wherein the transforming maps the frequency-domain features extracted from the signals generated by sensors operatively coupled with the host device to the plurality of frequency-domain features extracted from the device-specific alien dataset.

8. A system, comprising:
a processor configured to initiate operations including:
retrieving with a host device a device-specific alien dataset corresponding to an alien device, wherein the retrieving is from a remote data storage device communicatively coupled with the host device;
training a machine learning model based on a plurality of frequency-domain features extracted from the device-specific alien dataset;
extracting a plurality of frequency-domain features from signals generated by sensors operatively coupled with the host device;
performing a real-time frequency bin adaptation of the frequency-domain features extracted from signals generated by sensors operatively coupled with the host device; and
based on the frequency-domain features extracted from signals generated by the sensors operatively coupled with the host device, as adapted, determining an inference using the machine learning model.

9. The system of claim 8, wherein the processor is configured to initiate further operations including selecting the device-specific alien dataset from a plurality of device-specific alien datasets, wherein each of the plurality of device-specific alien datasets is derived from electronic signals captured by one or more sensors of one of a plurality of alien devices, wherein the selecting is based on metadata descriptors generated by a data collection manager.

10. The system of claim 8, wherein the processor is configured to initiate further operations including performing a frequency bin normalization on the plurality of frequency-domain features extracted from the device-specific alien dataset, wherein the training comprises training the machine learning model based on the plurality of frequency-domain features as normalized.

11. The system of claim 8, wherein the determining is based on a ratio of frequency responses to a wide-frequency sweep signal by the host device and the alien device.

12. The system of claim 8, wherein the processor is configured to initiate further operations including detecting a battery level of the host device and determining, based on the battery level, a number of frequency bins for performing at least one of a frequency bin normalization or a real-time frequency bin adaptation by the host device.

13. The system of claim 8, wherein the processor is configured to initiate further operations including augmenting the device-specific alien dataset with an adapted inference dataset generated by the host device in response to determining that a distribution distance between the device-specific alien dataset and the adapted inference dataset is less than a predetermined threshold.

14. A computer program product, the computer program product comprising:
one or more computer-readable storage media and program instructions collectively stored on the one or more computer-readable storage media, the program instructions executable by a processor to cause the processor to initiate operations including:
retrieving with a host device a device-specific alien dataset corresponding to an alien device, wherein the retrieving is from a remote data storage device communicatively coupled with the host device;
training a machine learning model based on a plurality of frequency-domain features extracted from the device-specific alien dataset;
extracting a plurality of frequency-domain features from signals generated by sensors operatively coupled with the host device;
performing a real-time frequency bin adaptation of the frequency-domain features extracted from signals generated by sensors operatively coupled with the host device; and
based on the frequency-domain features extracted from signals generated by the sensors operatively coupled with the host device, as adapted, determining an inference using the machine learning model.

15. The computer program product of claim 14, wherein the program instructions are executable by the processor to cause the processor to initiate operations further including selecting the device-specific alien dataset from a plurality of device-specific alien datasets, wherein each of the plurality of device-specific alien datasets is derived from electronic signals captured by one or more sensors of one of a plurality of alien devices, wherein the selecting is based on metadata descriptors generated by a data collection manager.

16. The computer program product of claim 14, wherein the program instructions are executable by the processor to cause the processor to initiate operations further including performing a frequency bin normalization on the plurality of frequency-domain features extracted from the device-specific alien dataset, wherein the training comprises training the machine learning model based on the plurality of frequency-domain features as normalized.

17. The computer program product of claim 14, wherein the determining is based on a ratio of frequency responses to a wide-frequency sweep signal by the host device and the alien device.

18. The computer program product of claim 14, wherein the program instructions are executable by the processor to cause the processor to initiate operations further including detecting a battery level of the host device and determining, based on the battery level, a number of frequency bins for performing at least one of a frequency bin normalization or a real-time frequency bin adaptation by the host device.

19. The computer program product of claim 14, wherein the program instructions are executable by the processor to cause the processor to initiate operations further including augmenting the device-specific alien dataset with an adapted inference dataset generated by the host device in response to determining that a distribution distance between the device-specific alien dataset and the adapted inference dataset is less than a predetermined threshold.

20. The computer program product of claim 14, wherein the processor is configured to initiate further operations including transforming the frequency-domain features extracted from the signals generated by sensors operatively coupled with the host device, wherein the transforming maps the frequency-domain features extracted from the signals generated by sensors operatively coupled with the host device to the plurality of frequency-domain features extracted from the device-specific alien dataset.
